(19) United States
(12) Patent Application Publication
(10) Pub. No.: US 2007/0055637 A1
(43) Pub. Date: Mar. 8, 2007

(54) Systems and methods for automated construction claim investigation, mediation and collection

(76) Inventor: Norman A. Nelson JR., Hollis, NY (US)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(21) Appl. No.: 11/441,734

(22) Filed: May 26, 2006

Related U.S. Application Data
(60) Provisional application No. 60/684,850, filed on May 26, 2005.

(51) Int. Cl. G06Q 99/00

(52) U.S. Cl. 705/80

(57) ABSTRACT

A system and method for investigating and mediating construction claims is presented. In exemplary embodiments of the present invention a construction claim can be mediated by fully investigating the details and context of a construction claim; determining the actual causes for the lack of payment; determining the key parties and the available leverage that can be used to achieve resolution; and engaging the key parties and applying that leverage to reach settlement, where one or more of said investigating, determining, engaging and applying is effected via electronic telecommunications or with the assistance of a computer. In exemplary embodiments of the present invention a computer-based system can assist a construction claim mediation practitioner in his application of the methods of the present invention to actual cases. Such assistance can include, for example, providing a practitioner with an organized computer-based environment in which to manage his cases, and can, for example, include prompting the practitioner to acquire the necessary information to implement the methods of the present invention, analyzing the case based on built-in intelligence and providing proposed strategies, automatically generating needed letters and emails to send out as well as checklists to help a practitioner stay on top of each case being handled.

### CROSS REFERENCE TO RELATED APPLICATIONS

This application claims the benefit of U.S. Provisional Patent Application No. 60/684,850, filed on May 26, 2005, which is hereby incorporated herein by reference as if fully set forth.

### TECHNICAL FIELD

This invention relates to dispute resolution, and in particular to a computer assisted system and method for the collection, investigation and mediation of mechanic's liens and large balance construction claims.

### BACKGROUND OF THE INVENTION

Anyone familiar with the construction industry is aware that when a job or a portion of a construction contract is completed, there are often disputes as to the final amount to be paid to the contractor. These disputes arise from a variety of causes. Sometimes the beneficiary of a construction contract asserts that the work called for under the contract was not done completely, or was not done in a professional and workman-like manner. Alternatively, the beneficiary of a construction contract (e.g., a building owner, a tenant in possession of a premises or a general contractor managing a construction project) can assert that there are a number of charge-backs, or credits, against the remaining outstanding balance of the construction contract, due to the contractor having left unfinished items or portions of the contract or having not done something properly, which requires engaging another firm to come in and fix it.

Alternatively, for example, beneficiaries of contracts may feel that they had been overcharged from the outset, but had no choice except to agree. Therefore, when the time comes to pay the remaining balance on a construction contract, they are simply looking for a discount which, in their minds, they feel is only “right.”

Or, for example, construction contracts have certain ministerial or administrative conditions which need to be fulfilled, such as submission of hours worked for all employees of the contractor who worked on the job in order to qualify for certain payments. Often, documentation is sloppy, or incomplete, and beneficiaries of construction contracts exploit this situation, either because they do not trust that all the hours were actually performed, or because they see an opening to shave some costs off of the construction project, and refuse to pay.

Also, for example, issues involving change orders often create disputes in construction contracts. A change order is an additional job, portion of a job, or item of work requested by the beneficiary of the contract after the contract has been signed, which exceeds the original scope of the contract. Sometimes there is a dispute as to whether a change order does in fact exceed the original scope, or was intended to be included. Other times it is clear that the change order did exceed the original scope, but because the parties did not fully document the requested and agreed-upon change order, although the contractor did the work, the beneficiary refuses to pay. In either scenario, a contractor seeks to be paid a final balance inclusive of all change orders, the beneficiary refuses, and a dispute emerges as to what change orders were agreed to and what were the agreed-upon additional fees for performing the additional work.

Each of the above describe scenarios can result in a dispute. When construction personnel end up in disputes with the contract beneficiaries, such as, for example, general contractors, building owners, construction managers working for a long-term tenant at the site, etc., tempers can flare and emotions can run high. Tradesmen often take great pride in their work, and they are reticent to hear that there is some problem with work quality or completeness. Alternatively, building owners and others sometimes have a perception that contractors and tradesmen charge for work that's not done, or overcharge for the work that is done, and they are seeking to pay less. This posturing of stereotypes, assumptions and emotions can often result in shouting matches and standoffs, and a substantial unpaid balance on a construction contract at the end of a job.

Conventionally, there are various remedies available to a contractor or subcontractor desiring to be paid on a disputed construction contract. One alternative is to file a construction lien. In the world of construction claims, there is a legal security device known as a “contractor's lien” or a “mechanic's or materialman's lien.” These devices give a contractor of, or a supplier of materials to, a construction project, a right to place a lien upon the real estate where the project is located to secure the payment of his claim. In most states there is a time limit in which a mechanic's or materialman's lien must be filed, which is measured from the last day that work was performed under the contract, and a second time limit in which a filed lien must be foreclosed by judicial procedure. If either time limit is exceeded the lien right is lost. When construction claim disputes emerge, if the parties reach a standoff, a contractor, having effectively no one to talk to on the other side, often sees little choice but to file a lien himself, or to hire an attorney to file it and then proceed to foreclose it.

Alternatively, there are situations where a contractor or subcontractor has given up the right to place a lien upon the property ab initio. In such cases, the building owner, the construction manager or the general contractor has made it a condition of the contract that a lien release be filed by all subcontractors and suppliers. Or, perhaps, the contractor has not given a lien release but does not meet the statutory requirements in his locale for filing a construction lien, such as, for example, a required notice to an owner prior to beginning work, which is often a prerequisite to filing a mechanic's or materialman's lien in many jurisdictions. In this situation, if negotiations have reached a standoff, and no lines of communication remain open between the contractor and the beneficiary of the contract, an aggrieved contractor can forward his claim to a collection agency for collection, or can forward it to an attorney to commence a lawsuit.

Such conventional methods are often the least efficient to actually resolve an outstanding construction claim. Once an attorney takes legal action, such as the filing of a lawsuit or the filing of a construction lien, the other side generally goes into an aggressive defense mode. The same course of events usually occurs if an aggrieved contractor hires a collection agency to attempt to collect the claim. Because collection attorneys and collection agencies often work on contingency, and are often jaded by the plethora of excuses and stories that they hear each day from debtors, they tend not to be receptive to compromise and tend to reject the idea that there may be some valid setoffs or charge-backs on the other side of the construction contract. Needless to say, meaningful negotiation towards resolution rarely occurs, and legal and/or collection fees and costs often consume a significant portion of any ultimate recovery.

Additionally, even if open to reaching a reasonable compromise, collection companies or other collection personnel tend to find themselves completely out of options once a construction lien has been filed, demand has been made for payment to the obligor on the construction contract, and said obligor has refused payment. At such juncture the conventional approach is simply to declare the matter at a standoff and recommend litigation.

What is thus needed in the art is a system and method for the investigation, mediation and collection of mechanic's liens and large balance construction claims that actually gets the parties engaged in a dialogue towards resolution back together, or musters the necessary leverage to convince the parties, without taking legal action, that it is in everyone's best interest to reach resolution on a construction claim, without the high costs, delay, and aggravation generally associated with legal action and/or collection agency activity.

### SUMMARY OF THE INVENTION

A system and method for investigating and mediating construction claims is presented. In exemplary embodiments of the present invention a construction claim can be successfully investigated and mediated by fully investigating the details and context of the construction claim; determining the actual causes for the lack of payment; determining the key parties and the available leverage that can be used to achieve resolution; and engaging the key parties and applying that leverage to reach settlement, where one or more of the investigating, determining, engaging and applying is effected via electronic telecommunications or with the assistance of a computer. In exemplary embodiments of the present invention a computer-based system can assist a construction claim mediation practitioner in his application of the methods of the present invention to actual cases. Such assistance can be, for example, providing a practitioner with an organized computer-based environment in which to manage his cases, and can, for example, include (i) prompting the practitioner to acquire the necessary information to implement the methods of the present invention, (ii) analyzing the case based on built-in intelligence and providing proposed strategies, (iii) automatically generating needed letters and emails to send out, as well as (iv) providing electronic checklists to help a practitioner stay on top of each case being handled.

### BRIEF DESCRIPTION OF THE DRAWINGS

FIG. 1 is a process flow diagram of a first exemplary pre-mediation phase according to an exemplary embodiment of the present invention;

FIG. 2 is a second exemplary pre-mediation phase according to an exemplary embodiment of the present invention;

FIG. 3 is a process flow diagram of a first portion of an exemplary mediation phase according to an exemplary embodiment of the present invention;

FIG. 4 is a process flow diagram of a second portion of an exemplary mediation phase according to an exemplary embodiment of the present invention;

FIG. 5 is a process flow diagram of a third portion of an exemplary mediation phase according to an exemplary embodiment of the present invention;

FIG. 6 depicts various reporting events according to an exemplary embodiment of the present invention.

### DETAILED DESCRIPTION OF THE INVENTION

In exemplary embodiments of the present invention a construction claim can be successfully investigated and mediated by using a variety of creative and non-obvious steps to bring about resolution. Such creative techniques include fully investigating the details and context of the construction claim; determining the actual causes for the lack of payment; determining the key parties and the available leverage that can be used to achieve resolution; and engaging the key parties and applying that leverage to reach settlement.

In exemplary embodiments of the present invention some or all of the following actions can be taken in the successful investigation and mediation of a construction claim according to the above-described process. For ease of illustration, in what follows a scenario where a construction claim made by a subcontractor is sought to be mediated and collected shall most often be described. It is understood that the methods and systems of the present invention can equally apply to claims by a general contractor against a contract beneficiary, claims by a second or third tier subcontractor, or claims made by any other party with a valid construction claim against any other party responsible for payment, directly or indirectly. In general the term “construction claim” will be used throughout this description. Such term is intended to be general, and to encompass all types of such claims, including both those that are associated with mechanic's, materialman's or other liens, and also those not secured by a lien. For ease of illustration, the titles of key parties to a construction claim mediation are sometimes capitalized, so that they can be easily identified in example scenarios. Additionally, the term “subcontractor” is understood to include subcontractors of a general contractor or of any other subcontractor, thus including subcontractors of any and all tiers. When a strategy for a case where a lien is involved is described, it is understood that the strategy can equally apply to the exemplary lien discussed or any other type of construction lien, and a particular type of lien (e.g., “mechanic's”, “materialman's”, “public project lien”, etc.) described is exemplary and for illustrative purposes, and not limiting.

It is noted that the following described creative mediation actions, techniques and strategies are in the nature of colors on a palette, or arrows in a quiver, and it is the context and details of a given case that drives which actions can be taken, in what sequence and with what emphasis. Ultimately it is the mediator who is the artist or the archer that judiciously uses the available tools. Thus, the methods of the present invention will also be illustrated below by various case studies and real-world examples to illustrate how such tools and techniques can be combined and in what sequence. Additionally, systems methods according to the present invention can be used as the basis of a construction claim mediation business, either in a stand-alone context or in a franchisor-franchisee structure. Additionally, the methods of the present invention can be performed with the guidance and assistance of a computer-based system, which can for example, encode the intelligence of the various construction mediation tools and techniques of the present invention and act as an electronic mentor, supervisor, guide and/or teacher to a user.

Summary of Creative Mediation Techniques

In exemplary embodiments of the present invention, the following techniques can, for example, be used, inter alia,
1) Contacting the Director of Facilities for a major tenant buildout;
2) Contacting by telephone and facsimile the managing agent, property manager, or corporate attorney for a building owner in which a Subcontractor has filed a mechanics lien;
3) Filing a complaint with the key executives of a major corporate client of the General Contractor. Simultaneous letters to CFO, COO, Controller and Director of Construction, as well as follow-up telephone calls and facsimile correspondence;
4) Letters and telephone calls to the financing entity of the construction project, i.e., where the progress payments originate and are sent to the General Contractor. A forward request for a direct or two-party check, all relevant lien or claim backup sent with such a written demand;
5) For state, municipal and city projects where there is a payment and performance bond, submission of proof of claim backup to state and municipal agency, as well as the attorney and Senior Claim Analyst of the surety company and the General Contractor's key executives, all letters followed with follow-up telephone calls;
6) Simultaneously contacting the General Construction Subcontractors simultaneously by written and telephone demand and submitting uncompleted punch list to arrange an onsite mediation meeting or walk through at the construction project site;
7) Requesting a two-party check or direct check from the General Contractor's client, submittal of backup documentation to the key executives, CFO, President, Controller, Construction Manager, etc., and substantiating that the Subcontractor's line items of work are completed;
8) Directly contacting the General Contractor's Subcontractors who have not completed their line items of work, getting a written commitment from each Subcontractor that they will receive payment upon completion of their work. Facsimiles and follow up calls simultaneously sent to the key executives; and
9) Contacting Director of Construction and the financing entity for the construction project. Submitting of change orders with supporting documentation to Director of Construction, as well as Project Executives with the General Contractor. Arranging meeting onsite at the project location, with General Contractor's Executives, Owners Representatives, Director of Construction. Prior to the meeting having the Subcontractor (i.e., the mediation client) recreate a time line and quantify specifically as to the dates and individuals that were present when they were instructed to execute the change order work. Placing a quantitative measure or value on each change order. Consulting Subcontractor's contract to investigate how change order related work is handled.

When a mechanic's lien is filed against a company during a major tenant buildout, a mediator can contact by telephone and facsimile the Director of Construction and facilities, the Chief Financial Officer, the corporate office key executive, the owner of the property, the Property Manager, the Owner's Attorney, and any other related parties. Bringing a copy of supporting documentation, the lien and a demand letter directed to the owner's representative or attorney can catalyze forward movement of a mediation or resolution process.

When a Subcontractor is owed money by a General Contractor who has a relationship with a major corporate client, an effective approach to the collection and mediation effort in exemplary embodiments of the present invention can be to determine the key decision makers at that client and file a presidential complaint with copy to the CFO, Director of Construction, Controller, Board of Directors, etc. This can, for example, be executed simultaneously, in written form and via follow-up calls to all key players, in a consistent and methodical manner.

Additionally, it is often useful in the collection, investigation and mediation of mechanic's liens and construction claims to strategically reach out to the financing entity, and the individual there that authorized the financing of the project in question. In implementing such a strategy all the relevant documentation, including a copy of the lien, can, for example, be sent to the individual at the financing entity. Because a General Contractor can receive progress payments from a client that has in turn received financing either from a bank, private investment group, state or municipal agency, a letter with all the relevant documentation and a series of telephone calls to the key executives that financed the construction project can, for example, facilitate a meeting between the Subcontractor and the General Contractor to try to resolve the lien or construction claim dispute through mediation according to exemplary embodiments of the present invention.

When, for example, a Subcontractor is working for a General Contractor who is working for a city, state, federal agency, bank, college, hospital or other public or quasi-public entity, there is often a payment and performance bond associated with the project. In such contexts this information can be obtained under the Freedom of Information Act by written request to the appropriate agency or end user. A subsequent written demand with lien or claim back-up data can, for example, be submitted (with or without a proof of claim affidavit submittal form) to the Chief General Counsel and Senior Claim Analyst of the surety company. Such a written demand can be coupled with simultaneous telephone calls to the appropriate parties.

For example, say that a Subcontractor is working for a General Contractor who is working for a major corporate client. It is further assumed that the Subcontractor was told by the General Contractor's Project Manager to do work that falls under change orders, and the Subcontractor was verbally advised that payment would be made for this extra work. The Subcontractor completed the work called out under the change orders; it is assumed for illustration purposes that there were three change orders that totaled $100,000 over the principal contract amount. In such a scenario, for example, the (major corporate) client's Director of Construction and the financing entity to the construction project can be contacted, and the change orders can be submitted with supporting documentation of the completed work to both the corporation's Director of Construction and the Project Executives with the General Contractor. Subsequently a meeting can be arranged on site, at the project location, with the General Contractor, Project Executives, Owner's Representative(s), and Director of Construction. Prior to this meeting, for example, the Subcontractor (i.e., the lien claimant) can recreate a timeline and quantify specifically, as to dates and the individuals that were present, when the change orders were requested and agreed upon.

For example, assume a Subcontractor works for a General Contractor who has been hired by an end user. The Subcontractor has filed a mechanics lien, and there is no movement with regard to payment. The General Contractor is contacted and responds “we have not gotten payment from our client (i.e., the end user) because one of the other Subcontractors has not completed their work.” In such a scenario the General Contractor can be contacted by fax and this can be followed up with a visit to the end user's Director of Construction (i.e., the General Contractor's client) at the project location. Then, for example, demand for payment can be made to the end user via a formal request with supporting backup, and a two-party or direct check from the end user can be solicited. This can alert the key executives, the CFO, etc. of the end user that a completed line item or items of work has not been paid and that a lien has been filed on their property. Although the lien may remain there until bonded or satisfied, this strategy can trigger a chain of events in the mediation process. The lien claim documents and demand for payment, in conjunction with follow up calls to the key executives with the end user, can force the General Contractor, the Project Managers and the Project Executives to sit down and come to an agreement to resolve the lien or claim dispute. This method of working forward and then backwards can be very effective in resolving mechanic's liens and construction claim disputes in which a Subcontractor is owed money by a Contractor who is owed money by a client or end user. The chain of command at the end user must be notified systematically by fax, telephone and onsite visit to project location. On the other hand, it is noted the more conventional obvious move of directly contacting the General Contractor initially is generally not an effective step in the mediation process.

As another example, assume a Subcontractor is owed final payment from a General Contractor, who is owed final payment from his ultimate client, the end user. Assume further that only two Subcontractors have completed their line items of work. As a result the end user refuses to pay the General Contractor the final payment which includes contract and retainage balance. In this scenario a mediator can contact the ultimate client, the owner's representatives (if they are different form the ultimate client, such as, for example, if the end user is a tenant contracting a build out or remodel) and the Subcontractors who have not completed their line item of work. An arrangement with the Subcontractors that they will get paid upon completion of their work within a reasonable time frame can, for example, be made. Additionally, for example, a review of open punch list items with the Subcontractors can be undertaken. Getting a written commitment from these Subcontractors and a estimated completion time to finalize corrective work, and submitting this to the owners representative and Project Executives at the General Contractor, can expedite resolution. Additionally, for example, an onsite walk-through can be arranged to concretize what work items are still actually open.

For example, assume a concrete Subcontractor claimant is a subcontractor to a Concrete Contractor who itself is a subcontractor to a General Contractor engaged by a library for a public improvement project. The Concrete Subcontractor, has a public improvement mechanics lien against the project. There is a bonding company and a surety company that represents the Concrete Subcontractor and General Contractor. Thus, in this example mediation client is a second tier subcontractor (a subcontractor to the Concrete Subcontractor, who itself is a subcontractor to the General Contractor)

Mediation actions to be taken in this scenario can include, for example: initial contact with the surety company Claim Analyst or General Counsel, obtaining a proof of claim affidavit, having the mediation client notarize the documents and submitting all the relevant backups to the surety company. Additional actions can include sending copies of the bond claim to the General Contractor and the General Contractor's other Subcontractors and Project Executives. After the bond claim is filed, both tiers of General Contractors, principals and their Attorneys can, for example, be contacted by written and telephone demand. This can prompt the bonding company to contact their surety representation and a mediation meeting can be set up between the principals of the Concrete Contractor, the (lien claimant) Concrete Subcontractor and the bonding company's surety representatives.

Exemplary System

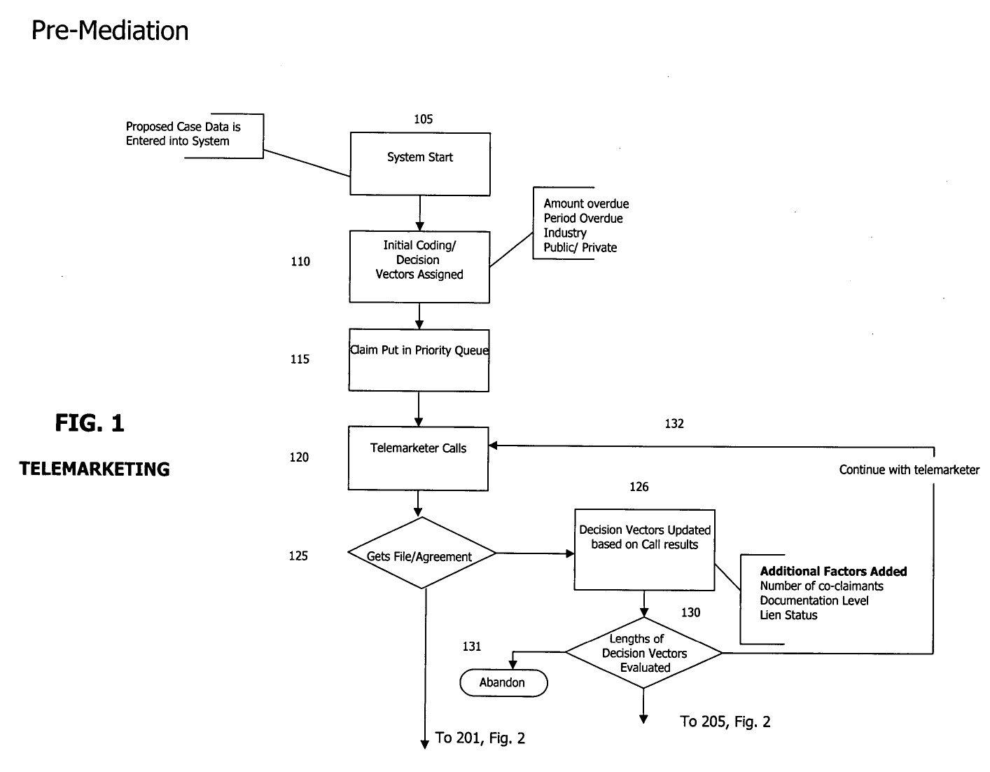

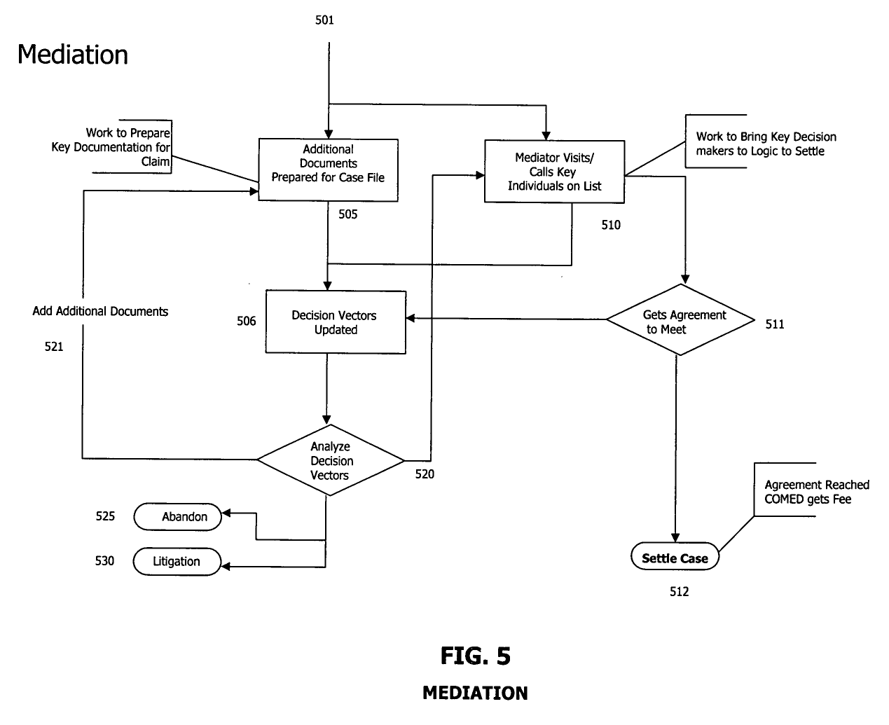

What will next be described, with reference to FIGS. 1-6, is process flow of an exemplary system, according to an exemplary embodiment of the present invention. Such an exemplary system can be in the nature of an expert system, and thus have intelligence that encapsulates the experiences and intuitions of a highly experienced construction mediation specialist, and can thus assist a construction claim mediation practitioner in his or her application of the methods of the present invention to actual cases. Such assistance can be, for example, providing a practitioner with an organized computer-based environment in which to manage his cases, and can, for example, include prompting the practitioner to acquire the necessary information to implement the methods of the present invention. Additionally, such a system can analyze a case based on built-in intelligence and evaluation metrics and provide proposed strategies, as well as automatically generate needed letters and emails to send out as well as checklists and case management tools to help a practitioner/user properly perform the methods of exemplary embodiments of the present invention.

As noted, such a system can be, for example, in the nature of an expert system that can store and encode intelligence which can assist a novice or even an experienced mediation specialist in the performance of various tasks needed to implement the methods of the present invention. Such an expert system can, for example, be created by articulating the intuitions and “gut-level sensibilities” that one or more expert construction claim mediation specialists have acquired based on their vast experience. Such articulation can be, for example, quantified in a set of rules, and/or in various metrics, functions and algorithms to be used to process, evaluate and operate on construction claim case data and make recommendations as to strategy and actions to take.

Such an exemplary system can, for example, assist in processing claims from the very beginning. When a prospective claim enters the system it can be analyzed for various factors. These can include, for example, the amount of the claim, the time it has been outstanding, the industry and various other factors. These factors can be reduced to a list of numerical parameters (a vector). From this vector lengths can be generated, for example, for the various pending decisions. At first, for example, these decisions can be to simply determine which leads are the most likely to be profitable and place them at the head of a processing queue for the telemarketers. There can also be vectors, for example, for decisions to either abandon the case as an unworkable lead or to pass it to a closing specialist. A good exemplary visualization of such vectors is a set of arrows that can represent the different decisions. As information enters the system, the arrows can change in length. The system can make decisions based on the relative lengths of the vectors, for example. More precisely, the system can have several length measuring functions (metrics), whose values can be compared to determine which decision is most likely the best at any point in time. This can, for example, simulate the way that a human being would make decisions based on their finely honed instincts and experience.

For example, each time a telemarketer makes a call to a prospective mediation client, the results can be entered into the system to determine the current state of the vectors. If certain factors start coming up, such as, for example, a disagreement about punch lists, the arrows associated with sending the claim to a closer can get longer. On the other hand, if a telemarketer is making a large number of calls to a lead but is not getting business, then the vector for abandoning the process can grow. This same process can occur, for example, when the lead is in the hands of a closer. His actions can change the sizes of the various arrows connected with each decision.

After a prospective case has been taken by a user, the lien or claim documents can undergo an initial analysis and a preliminary list of key players can be drawn up. An exemplary system can produce the necessary documentation and automatically generate faxes to send out (which can, for example, be done completely electronically within the case management environment itself), while a mediator can make a first batch of calls and visits. This can take place in a very short time so as to have a blitz effect.

After this blitz there can be, for example, an investigative period. During this period, a mediator can work to determine enough information about the case to produce a plan for its resolution. As information is entered into an exemplary system, it can be evaluated by system algorithms and decision modules. As more data is entered, the system can guide the mediator towards a plan to close the case.

In exemplary embodiments of the present invention, sets of decision vectors can, for example, be made for each of the individuals and documents outlined in the plan. Further individuals can be added later, as well. The decisions in question can be, for example, to continue working with each individual, or to decide that that individual has reached the point where he should be able to resolve the claim, or to abandon that person as an inefficient use of resources. As a mediator/user works on the claim the system can change the lengths of the vectors. The system can also perform an important additional function at this point. It can, for example, estimate which activities (documents and people) can most help the mediator to bring the claim to a successful conclusion or eliminate it if the situation is hopeless. Once again, in so doing, the system can emulate the instincts of an experienced mediator.

In an exemplary embodiments of the present invention, such a system can, for example, be self improving. The functions that determine the relative lengths of the various decision arrows can be functions of both the specific factors of the claim and a set of weighting constants. These constants can be thought of as representing how important various factors are in evaluating the claim. The initial values of these constants can, for example, be determined by consulting with professionals in the field. As the system is used, the information can be stored in a database. Periodically, this information can be reviewed and the constants adjusted. There can be, for example, both a relatively quick running method for slightly perturbing the constants, as well as a much more complex method for analyzing constants without presuppositions of their approximate values. By running this process, a system can learn from experience just as a professional mediator would.

In exemplary embodiments of the present invention each construction claim mediation case (both active cases and prospective cases being sought) can be expressed as a vector. The system can, for example, work with lists of ratings based on factors involved in the claims. The system can at first work with just a first order approximation of the relationship between the factors and the length created by the functions. This can give, for example, a first order polynomial of the form A₁X₁+A₂X₂+ . . . AnXn where the As are the weighting factors and the Xs are the indices from the case. If useful, cross terms can be added, as well as other higher order terms.

Periodically, for example, the constants can be evaluated to determine those that best fit the situation. For example, in one system, the sum of the lengths of the items that generated business can be the highest while the sum for the rejected can be the lowest. This process can be implemented for each of the vectors, and can be fairly easily done when it is reasonably certain that the constant values are close to correct. One can simply individually alter them slightly and then see in which direction the match is better. Doing this with each of them can provide a better fit. If it does not, that implies the need for various cross terms, i.e., the influence of the various factors is not independent.

In one exemplary system, the values of Xᵢ can all be in the range of 0 to 1. They can, for example, be divided into two types: Nominative Types, representing things like the industry of the claimant, or the presence of a specific item or document, and Ratio Measurements, representing things like time overdue or the amount of the claim. These types can, for example, be put through a normal function to generate their values. For example, a system can start with a normal curve with just a mean and standard deviation. If needed, a given function can be changed to represent different levels of attenuation on the sides.

Thus, in exemplary embodiments of the present invention, such a system can allow a relative novice to perform from the very beginning as if they themselves had years of built-up expertise. In exemplary embodiments of the present invention, a franchise arrangement can be set up wherein a franchisor trains franchisees in the methods of the present invention and provides the franchisees with such an exemplary expert system, that can allow them to perform their duties efficiently and successfully, as well as provide them with the benefit of a “virtual senior partner”, assisting such a franchisee at every step of the way.

Additionally, in exemplary embodiments of the present invention an expert system can maintain databases of relevant construction industry and real estate data, and automatically cross-reference and research any construction claim in a given market as to building owner, key parties related to the property or project, and key relationships of the claimee that may be available to exploit to bring pressure to bear on the claimee to reach a settlement. Such a database can also, for example, maintain a history of all cases handled throughout the system, and can cross-reference and supply the names of key parties in entities involved in current cases. Additionally, in a franchise context, each franchisee can, for example, be required to enter each case into an exemplary system, and manage the case through the system. Data entered into the system by the franchisee at each of the various points in the life of a mediation case, can then be used to generate reports back to the franchisor for data mining, monitoring and analysis by the franchisor for various purposes.

Process flow through an exemplary system for an exemplary mediation case according to the methods of exemplary embodiments of the present invention, can be conveniently divided, for example, into two phases: a pre-mediation phase and a mediation phase.

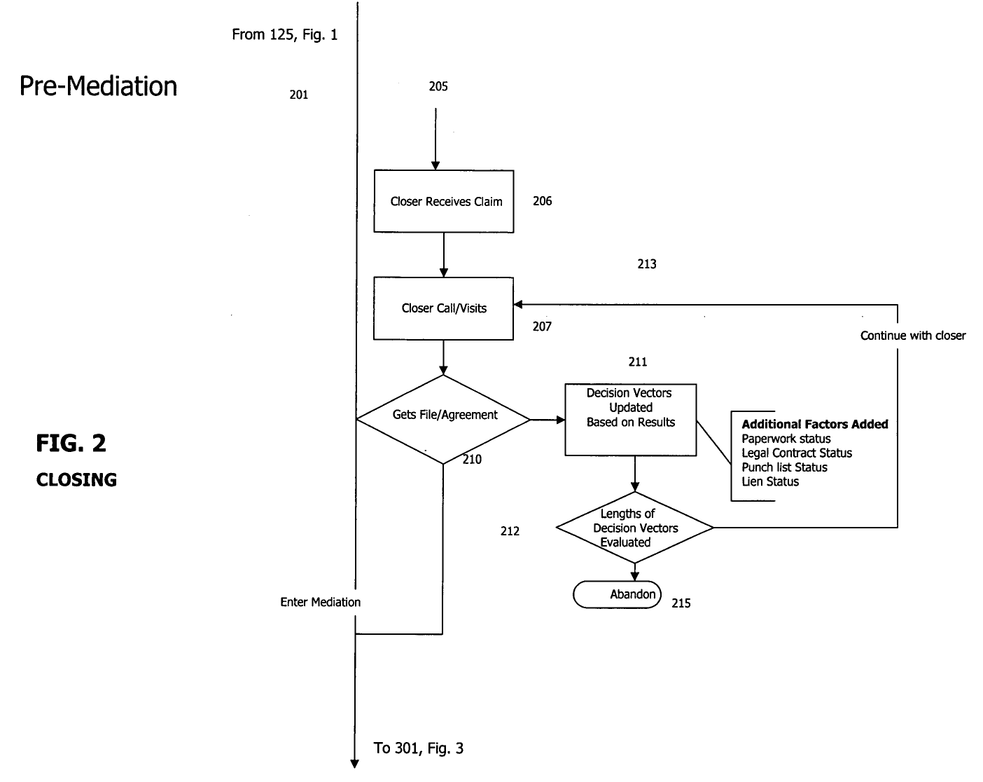

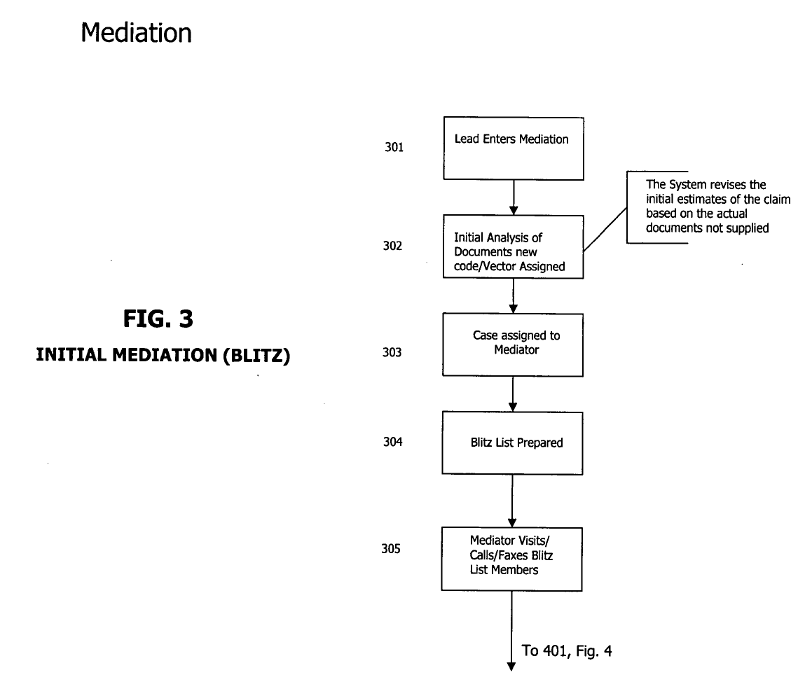

FIGS. 1-2 are directed to an exemplary pre-mediation phase, and FIGS. 3-5 are directed to an exemplary mediation phase, as next described. What is next described is exemplary process flow according to an exemplary embodiment of the present invention with reference to FIGS. 1-6.

Exemplary System Process Flow: Premediation

With reference to FIG. 1, a prospective claim enters the system when data for a proposed prospective case is entered into the system. This is shown as the input to 105. The proposed case data can include, for example, the amount of the claim, the time the claim has been outstanding, the industry sector in which the claim arose, and various other factors. At 110, this data can be reduced to a list of numerical parameters, such as, for example, a vector. From this vector, links can be generated for the various decisions that are pending. Initially, these decisions can simply be the determination of which prospective cases are most likely to be profitable. The most likely profitable prospects can be placed at the head of a processing queue for telemarketers to call. Thus, initial coding can occurs at 110, and claims can be ranked by probability of profitability in a priority queue at 115.

Using this priority queue, at 120, a telemarketer can call a prospective client to propose that their claim be handled by an exemplary claim mediation service. At 125, if the prospect agrees to retain the mediation service, then flow proceeds to 201 on FIG. 2, and the prospective case enters mediation. Alternatively, if at 125 the telemarketer does not procure the file and agreement to proceed, the data gleaned by the telemarketer in querying the prospective client can be used to update the decision vectors so that they can be evaluated at 130 to decide whether to proceed and hand over the case to a closer, at 205 on FIG. 2, or to abandon the case, at 131 on FIG. 1. A third alternative is that if at 130 there is still not enough information to decide, flow can loop back to the telemarketer via 132 who can make a subsequent call or calls to the client prospect at 120. If, for example, it is decided at 130 that the claim is worth pursuing, then flow can continue to 205 on FIG. 2, a closer can receive the claim at 206, and make a visit to the client prospect at 207. At 210, if the closer has obtained the file and agreement by the client prospect to retain the mediation service, then the file can enter mediation and flow can move, for example, to 301, on FIG. 3.

Alternatively, if at 210 the closer does not obtain an agreement to proceed, the decision vectors can, for example, be updated again at 211, and evaluated at 212 to decide whether the closer should continue pursuing the case at 213, or abandon the case at 215, or if there is not enough data to decide, flow can loop back via 213 to another closer call or visit at 207.

System Process Flow: Mediation

An exemplary mediation process will next be described with reference to FIGS. 3-5. With reference to FIG. 3, a case enters mediation at 301. At 302, for example, an initial analysis of the documents can be undertaken and a mediation status vector can be created. Here, an exemplary system can, for example, revise the initial estimates of the claim based upon actual documents received which were not supplied in the pre-mediation phase. At 303, the case can be assigned to a mediation specialist, and at 304 a blitz list can be prepared. A “blitz list” is a list of key players whose assistance or decisions are critical in bringing a construction claim mediation to a successful close. Thus, at 302, using documents received from the client such a preliminary list of key players can be extracted from that data. The system can, for example, then produce necessary documentation by which a mediator can contact the people on the blitz list, such as, for example, via faxes, emails and letters.

In exemplary embodiments of the present invention an exemplary system can, for example, generate notes to a mediator as to what key items to look for or investigate further. All such system-generated documentation can be provided to a mediator, assigned at 303, and at 305 using the now prepared blitz list, the mediator can visit, call, fax and/or email, as may be potentially productive, to the various key players on the blitz list to advise them of the existence of the claim, the retention of the mediator and the desire of the claimant to resolve the claim in a win-win result for all parties.

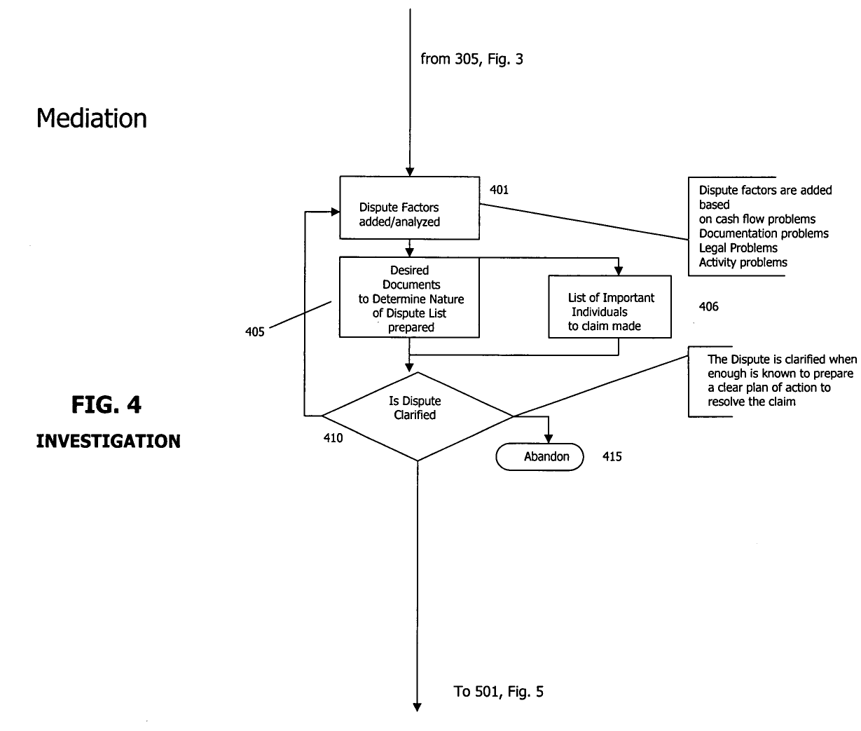

After the opening blitz at 305 (with reference to FIG. 3), the case can be investigated, as shown in FIG. 4. During this phase of an exemplary mediation, a mediator can, for example, work to identify enough relevant information about the case to produce a plan for resolution. Thus, at 401 dispute factors can be added and analyzed, and at 405 a list of desired documents necessary to determine the nature of the dispute can be prepared. In parallel to this processing, at 406 a list of individuals important to resolution of the claim can be generated, and at 410 the decision can be made, based upon these outputs, as to whether the dispute is now clarified. A dispute is said to be clarified when enough is known about it to prepare a clear plan of action to resolve the claim. Using the intelligence of an exemplary system, if the dispute is clarified, the system can assist a mediator in formulating such a plan. If at 410 the dispute is clarified and in the judgment of the mediator, as assisted by the system, it seems unlikely that anything can be collected, the case can be abandoned at 415.

Alternatively, if at 410 it is decided that the dispute is sufficiently clarified and there is no reason to abandon it, process flow can, for example, move to 501 and 505 where additional documents can be prepared for the case file, and at 510 a mediator can visit, call, or otherwise contact key individuals on the list. These tasks, can, for example, coalesce at 506, where the decision vectors can be updated so that at 520 an analysis of the decision vectors can be made to pursue one of three possibilities. At 525 the case can be abandoned. At 530 the case can be forwarded to an attorney for litigation, or at 520 a mediator can continue to deal with the key individuals on the list to try and bring about a settlement. In so doing, the mediator may procure an agreement by all parties to meet. If so, then process flow can move to 512 where, for example, the case can be settled and the mediation service can receive a fee. If no agreement is obtained at 511, then process flow can, for example, return to 506 where the decision vectors can be, for example, updated as a result of the mediator's attempts to bring about a meeting, and the decision vectors, now updated, can be further analyzed at 520 to determine once again, which of the three courses of action to take, as described above. At 520, if additional documents or other claim support evidence becomes available, flow can loop back via 521 to 505 and the new information can be integrated and analyzed by the system, as described above.

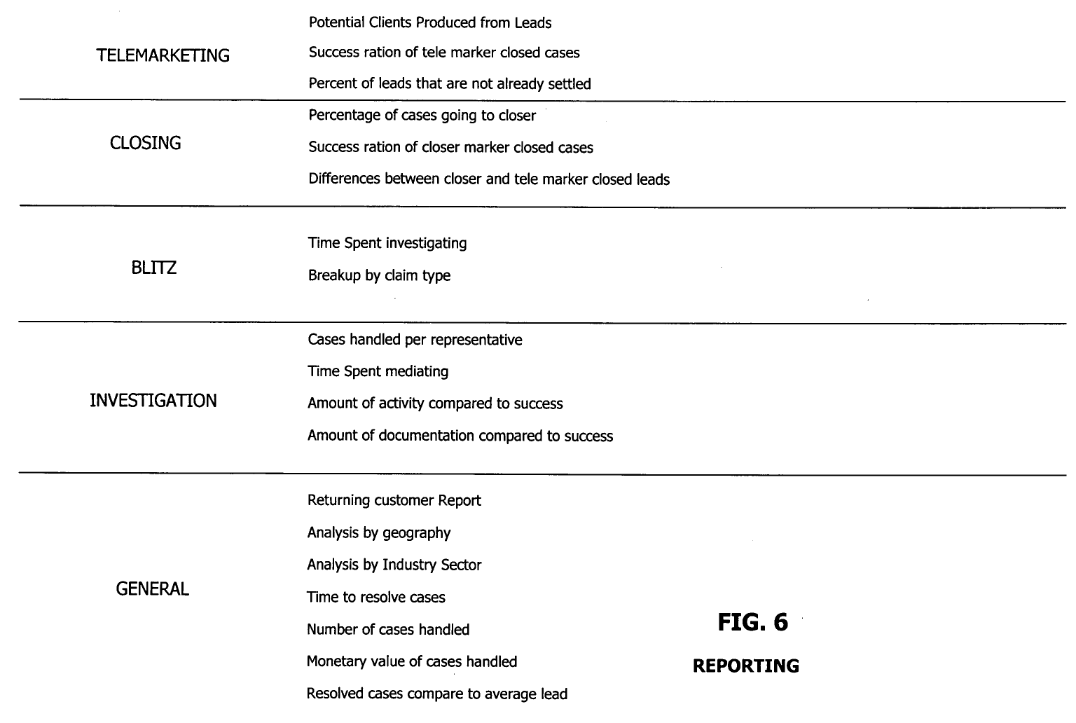

FIG. 6 depicts various monitoring metrics and indicia that an exemplary system could provide a mediator, a franchisor, or, for example, a manager of a mediation business in various exemplary embodiments of the present invention. As can be seen with reference thereto, at each stage of a given case, various monitoring and management results can be calculated and reported. In a franchise context, for example, such reporting indicia can be automatically generated at user defined intervals and electronically sent over a VPN or other data communications pathway to the franchisor from each local franchise office. Alternatively, for example, all local franchisee data can be always sent to a central system where all the processing is done (the local terminals being essentially remote interfaces to the central franchise-wide master system), and thus the central system can generate reports locally at any desired time interval.

Exemplary System Functionalities

In exemplary embodiments of the present invention an exemplary system can, for example, aid, prompt, document, facilitate and allow a user to perform the following functions:
1) Scan lease sources for viable accounts to pursue
2) Enhance the Telesales effort for filed liens—promote the unique steps necessary to successfully resolve case
3) Enhance cold calling marketing—again promoting the unique steps necessary to resolve a case
4) Update the database with information from closed deals—lien cases and construction claim cases
5) Execution of procedures to resolve lien or claim cases
6) Implement detailed non-obvious and varied steps to resolve the case-includes telephone calls, facsimile and onsite meetings
7) Provide automatic status updates to clients
8) Coordinate conference calls to clients, principals, general contractors and project managers
9) Final punchlist walkthrough
10) Facsimiles sent to all key players with the General Contractor or building owner positions. These faxes can also be sent to the lienor or client to keep them informed of all developments.
11) Three-Way Agreement Settlement discussions:
   Mediation specialist
   Claimant
   General Contractor, Principal or Project Executives
12) Manage and support implementing criteria to settle a lien or claim case involving a three-point multiple strategy execution, and
13) Determine the amount of the undisputed portion of the lien or construction claim, i.e., the percentage of value of completed work in relation to the total contract and change order balance, and deliver a believable conceptualization to the General Contractor of their legal options. These options include direct contact with the building owner's attorneys or managing agents that can be implemented to the fullest. In most cases these sequential steps should be implemented over a one to two week period in order to get the needed attention of General Contractor or end user decision makers to facilitate serious discussion that can lead to a firm verbal commitment, a pre-legal mediation meeting and final closure to the lien or claim case.
   In exemplary embodiments of the present invention, an exemplary system can, from a system database, cite actual case studies and examples of the three-way settlement discussions that can preclude final settlement among the parties.
   Specific events can occur when the Mediation Specialist is working a lien or claim case. The effect of telephone calls, facsimiles, and sending hard-copy documentation to the relevant decision makers must be monitored, an access to the Principal and/or key Project Managers is needed. A mediator should always get a cell telephone number from clients. There is a tremendous amount of information to obtain from the parties involved in the case.
   The sum total of ongoing due diligence resulting from collecting information by using the sequential, varied, non-obvious and unique patented steps can be the primary facilitation in effecting unilateral negotiations with the key individuals in each case. This can give necessary psychological and physical momentum to successfully resolve the case.
   In exemplary embodiments of the present invention, during the investigation a mediator can various wear hats and fill several roles:
   Negotiator
   Analyst
   Strategist
   Mediator
   Investigator
   Coordinator
   Teacher
   These roles can be interchangeable at any given point during negotiations with the key decision makers. This mindset of skills must be implemented across the board. From the beginning of marketing efforts with a client through the negotiations with the parties involved in the case, in order to effectively develop expertise as a mediation specialist a user must fulfill the needs of all parties to successfully resolve their cases.
   In exemplary embodiments of the present invention, a Mediation Specialist can input actual data obtained from the clients. An exemplary system according to the present invention can process and assimilate all data entered and actively guide a user to take the correct steps to facilitate the successful closing of the case.
   An exemplary system can, for example, track every movement of each case and report the status of each of the outstanding cases. All of the cumulative steps taken during the course of the case, the contacts, documentation obtained and actions taken can be, for example, recorded. After the case is successfully resolved the system can generate a monthly newsletter of successful case closing that can be used as a marketing tool for new and existing clients.
   An exemplary system can be able to track and retain information for an unlimited number of client's cases and give their status at any given point during the mediation and collection process. Information to be retained can include, for example, the following:
      Calls made to all the parties involved in the case
      Facsimiles sent to the key decisions makers
      Setting up mediation meetings between the parties
      Submittal of all relevant documentation to the parties
      Mutual discussion of potential settlement offers
      Knowledge of all relevant settlement documents
      Full assessment of case file change orders, back charges, related correspondence, contracts, proposals, final punch lists, etc.
   In exemplary embodiments of the present invention an exemplary system can track case file activity in all areas. It can track the information for a one-person franchise partner operation or a large franchise Partner with a full staff. Such an exemplary system can incorporate the following:
      Sequential steps to utilize on a case by case basis
      Tracking the fee structure
      Tracking all calls and correspondence
      Effects of the steps taken
      What are the most efficient strategies and methodologies to use
      Coordination of meetings
      Which parties to apply psychological leveraging to
      When to recommend legal action
      When to move to close the case
      Utilization of data from closed cases

Thus, in exemplary embodiments of the present invention intelligent solution capabilities can be integrated fully into the Franchise Partners daily operations.

In exemplary embodiments of the present invention a central office can, for example, track royalties and evaluate the volume of lien and claim placements for each Franchisee. Efficient training procedures for all phases of franchise operations from lien lead assessment, outbound marketing programs, investigation, collection and mediation of actual filed cases can be provided.

In exemplary embodiments of the present invention, an exemplary system can teach a novice collection mediation specialist or franchise partner to go through all the steps necessary to successfully resolve a case. All cases, from a simple one to a complex case requiring many steps to resolve, with multiple partners to negotiate with and multiple subcontractors to deal with can be handled by an exemplary system. Thus, every facet of mediation, investigation and collection strategies can be covered and managed.

Case study data that can be inputted into an exemplary system can be the result of actual business solicitation and new business generated by, for example, a mediator or a franchisee.

Because the various steps have similarity, however, the variation in the execution on a per case basis can in itself result in a system becoming sophisticated as a system is updated with data from actual cases.

In exemplary embodiments of the present invention, an exemplary system can recommend:
Which specific parties to call
Parties to engage in conference calls
Which parties to obtain hard copy date from
Which parties to have mediation meetings with
Which sequential steps to follow to resolve the case in the most efficient manner
When a Specialist should initiate settlement discussions with the various parties
If necessary, how to work with Attorneys and recommend legal action
Conduct on-site mediation meeting and walk-through regarding punchlist disputes
Conducting on-site mediation meeting to discuss back charges and percentage of project completion
Conduct mediation meeting to discuss change orders, extras and related correspondence
Conference calls with the relevant parties to develop information and dialogue flow
Due diligence discussions with all relevant parties in order to formulate a collection and mediation strategy relating to:
General Contracts Principal
General Contractors Project Executives
Lienors-Project Managers
General Contractors-Chief Financial Officer
Project Accountant
Bonding Company representative
Building owners' attorney
Building owners managing agent
Owner's Representative
Construction Manager's executives
Lienors principals
Attorney for General Contractor
Director of Construction for the End User
Director of Facilities
Executives for the Managing Agent
Bonding Company Attorney
Executives of the Financing entity, and
General Contractors Corporate Controller

In exemplary embodiments of the present invention, an exemplary system can generate specific facsimiles during the mediation, investigation and collection process. These faxes can, for example, start out as a demand for payment with accompanying documentation and encompass everything from a request for a follow up onsite mediation for a punchlist meeting to an offer to settle to a general contractor or end user.

In exemplary embodiments of the present invention an exemplary system can send the same information to a client as a series of status updates regarding the case. It is important that a client knows a mediator us on top of their case. Some cases may take several months to resolve. In exemplary embodiments of the present invention a mediator should also solidify his fee arrangement with the client as once this is done they are less likely to try and pull the case, even if it is taking longer than anticipated to resolve it. In exemplary embodiments of the present invention an exemplary system can store specific legal close-out documents so that a mediator, or for example, franchise partner can be familiar with the documents necessary to exchange to effectuate the final settlement.

Detailed Exemplary Case Studies

Because the methods of the present invention involve applying a variety of possible strategies and actions at the proper time and in the proper manner, the methods of the present invention as described above are best exemplified by actual case studies. Such case studies, beyond a mere listing of strategies, techniques, steps and possible actions that a mediator can take or implement, provide real-world context and illustrate how the various tools available to a mediator according to the methods of the present invention can be used in resolving real world construction claims.

General Approach to Mediation

In exemplary embodiments of the present invention a mediator seeking cases to mediate can procure a list of filed construction liens. Sources for such a lien list can include county records, or services which track such records. Such a lien list can be evaluated to predetermine which are viable leads to work. In such an evaluation, the size of the mechanics lien should not be the sole factor in choosing which liens to pursue. Money can be made on a $10,000 lien at 35% or on a $350,000 lien at 12%. In fact, it is generally better to have 10 liens with an average balance of $50,000 than 1 lien with a balance of $500,000, as a higher success ratio can be achieved. When a mediator looks at a mechanics lien list he can, for example, assess all of the following: the lien amount, when the lien was filed, the type of Subcontractor, General Contractor or supplier, knowing and understanding their trade designations. A mediator can, for example, familiarize himself with the entity the lien has been filed against by cross referencing the list to predetermine if there are other liens filed against the project or if the General Contractor claimee has other money owed to other Subcontractors. In general, a filed mechanics lien can have the following basic components:
1. The subcontractor/all types of subcontractors;
2. The General Contractor (Prime or Sub-General Contractor);
3. The Supplier;
4. The location of the filed lien (address, county, city, borough, etc.).
5. The corporate entity of the property owner;
6. The corporate client, or name of the Construction Project;
7. The Subcontractor(s), General Contractor and/or Construction Manager for the Project;
8. The date the mechanic's lien was filed; and
9. The amount of the filed mechanic's lien.

In exemplary embodiments of the present invention a mediator can conceptualize the scope of the project, whether it is ongoing or near completion, and what is the estimated total contract the client prospect has in relation to the size of the overall construction project. Looking at a lien lead can give an indication of how viable the claimee is, by asking the following questions:
Is this a General Contractor that has repetitive liens against their projects?
Are there other subcontractors that are owed money with regards to the same construction project that also filed liens?
Is this lien recently filed or has it been on the lien lead list for more than one month?

In exemplary embodiments of the present invention, If calling on a $100,000 lien, even before speaking to the key decision-maker, it is often desirable to quote a fee between 15-20% of the recovery. If the case is settled for $75,000 in a time frame of 30 days, the potential fee is $11,250-$15,000. In exemplary embodiments of the present invention, it is advisable to use the 20% rule, where a prospective mediation client is told they will get back 80% of their money. On substantial lien and construction claim cases, the fee can be dropped, for example, to the 12-15% range.

In exemplary embodiments of the present invention, when calling liens from a lead list, making a presentation or sending out brochures by email or facsimile, it can be determined if there is a sense of urgency on the part of the client prospect or if the client prospect is willing to enter into negotiations for the fee or advance retainer for handling their lien case. In perusing the mechanics lien lists in a given local market, a mediator can, for example, call first and ask, “Are you a painting contractor, or are you an electrical contractor”, or “are you an HVAC or heating ventilation or air conditioning contractor?” In exemplary embodiments of the present invention, a mediator can determine to what type of subcontractor or general contractor the presentation is to be made. If the end user is recognized, such as, for example, a notable college, bank or national retail chain, the collectibility of the lien or claim can be more easily conceptualized by a mediator.

In exemplary embodiments of the present invention, the location of a project can also indicate if it is an affluent area and a prestigious building, or a depressed area; whether it has a high or low crime rate, whether it is prime space conversion, a tenant buildout, or moderate to expensive real estate. It can also be determined if it is in the east, west, north or south side of the city, town or suburb, for example. The location can also indicate a commercial or residential building. Thus, in an exemplary embodiment of the present invention, evaluating the project address and location can be highly beneficial. The name of the subcontractors or general contractor can give insight into the viability of a lien or claim; i.e., are they a recognizable general contractor or are they a small general contractor? Are they a financially sound company, or are they a company that always has subcontractors filing against them?

Case Studies

In exemplary embodiments of the present invention, by using, inter alia, the criteria discussed above, a mediator can select, assess, analyze and review mechanics lien lists of daily or monthly filed mechanics liens. The following case studies illustrate methodologies and strategies to work a lien or construction claim case according to exemplary embodiments of the present invention. These case studies are based upon the actual experiences of the inventor. It is noted that in what follows the client of the mediation service is variously referred to as the “lien claimant”, “claimant” and/or “mediation client”, as may fit the context. Similarly, the mediation client's immediate obligor (e.g., a General Contractor where the claimant is a Subcontractor) is referred to as the “claimee.”

Case Study No. 1—General Contractor

In reviewing a mechanics lien list it was noticed that a general contractor filed a mechanics lien against a high-end national women's retail chain and designer. The lien amount was $381,000. The mediator called and spoke to the principal for the general contractor and made a presentation over the telephone. Subsequently, the mediator made an appointment to meet the client prospect's principal and after a one-hour discussion, closed the deal and negotiated a 15% contingency fee with a $3,000 retainer to be deducted from the 15%. The mediator requested copies of the contract, the filed mechanics liens, all correspondence, change orders, purchase orders, final punch list, a list of all of the relevant subcontractors, and a list of all the telephone numbers of all the project managers for the claimant and the end users, including cell phone numbers.

The mediator's review of the lien case file indicated that the client's total contract, including change orders, was $2.5 million dollars. The mediator asked the client how long they had been working for this client of theirs, and learned that they had a 10-year relationship and had completed many construction projects throughout the United States. The mediator called the client and asked the principal why they had had a falling out, and learned that towards the end of the project, progress payments slowed up, and as a result, the general contractor was late in paying his subcontractors. These subcontractors started filing mechanics liens against these two high-end retail stores. As a result of an uncompleted punchlist and filed liens, the end user would not continue to make progress payments until the general contractor resolve these issues. Review of the case file documentation and flushing out the appropriate questions to the claimant gave the mediation specialist a direction of approach to resolve this multi-faceted lien dispute.

As a mediation specialist, in conducting an investigation of a lien claim, it is necessary to speak with, and fax information to, as many key decision makers relevant to the construction project as possible. Armed with a list of all of the individuals that the claimant worked, the mediator had to go beyond these individuals to make all parties aware of the lien claim. In this scenario, the claimant was the Primary General Contractor who had a direct relationship with their client, the retail fashion chain. There was no intermediary. The General Contractor (the claimant), however, had employed at least seven Subcontractors, who were also owed at least 30% of the contract balance. The mediator's initial step was to reach out to the Director of Construction, the Chief Financial Officer and the Project Accountant for the General Contractor's client (i.e., the retail fashion chain).

It is generally advisable that key partners are put on notice with a letter and a copy of all hard copies, no matter how large the file is. After reviewing the file and speaking to the client, the mediator knew it was necessary to bring the client and the Director of Construction back together in a civilized setting. The client's principal was very angry; he was owed this money and he was getting real pressure from his subcontractors. The women's retail chain corporate officer was based in California, while the projects were in New York. It only made sense to have a meeting at the project location, especially since the end user's (i.e., the retail chain's) contention was that the project was uncompleted. The mediator arranged a walk-through of the construction project at various intervals. It is noted that all of the Subcontractors had additional work to do as listed on the uncompleted punch list according to the end user.

In exemplary embodiments of the present invention, In properly executing a mediation function, various options must be executed simultaneously to achieve momentum. The mediator obtained the punchlist from the end user and forwarded this list to the general contractor. The mediator subsequently arranged a meeting with the end user and the principal for the general contractor at the jobsite. Phase one of the punchlist was with the General Contractor, and phase two was with the General Contractor's subcontractors. It was then time to have a meeting with the Director of Construction (for the retail chain) at the project location.

The General Contractor's principal joined the mediator at both project locations, spent several hours in a walk-through and prepared a check list of what items the General Contractor would complete and what work items subcontractors would complete. Once an agreement was reached in principle, this was submitted to the retail chain's Director of Construction for final review.

In exemplary embodiments of the present invention, when working with a small group of individuals that are owed money, a mediator tries to reach a universally fair and acceptable arrangement. This is because all subcontractors on the same project will talk with each other, and there are no “secret deals.” The mediator was able to commit the subcontractors in a written agreement to finish their line items of work from the punch list, even though they were still owed their contract balances. Once the mediator got two subcontractors to get started on their punch list work, progress payments were made on a weekly basis and this caused the other five subcontractors to follow suit and complete their respective punch lists. The General Contractor also took the lead in completing their portion of the punch list items. Additionally, the mediator strategically filed written complaints with each of the building owner and managing agent for the property, and negotiated directly with the property owner's attorneys, thus using the leverage of the filed mechanics liens to the fullest extent.

Such astute use of leverage involves being always just short of having an attorney intercede via a lien foreclosure action, yet still keeping the thought paramount in the minds of the claimee's key executives that a default may be forthcoming from the building owner regarding their lease obligation to keep the property free of liens. Attorneys for the building owner will generally put their tenants on notice to resolve this dispute with the general contractor and get the mechanics liens off of the properties. The claimee and the fashion chain's Director of Construction signed a two-way agreement and agreed upon a weekly progress payment of $24,000 per week. The prioritization of the subcontractors' work during the punchlist cleanup process was agreed to be as though the project had never stopped. Initially the mediator had thought that the subcontractors could be trusted to complete their punch list assignments; however, when the mediator became aware that a couple of the subcontractors got behind the agreed work/payment schedule, this resulted in an inspection by the mediator of each subcontractor's punch list completion work prior to their weekly draw. The stipulated agreement resulted in a 3.5 month payout for a total sum of $369,000. The mediator controlled the disbursements of payments, even to their client, the General Contractor, who was to receive a $24,000 progress payment and exchange that check for the subcontractor's disbursements only after their portion of the specified work was completed.

Case Study No. 2—Specialty Drywall Contractor

A Specialty Drywall Contractor had a $2 Million dollar contract with one of the largest national movie chains in the United States. The disputed contract and change order balance was $500,000. When a lien this substantial appears on a mechanic's lien list, a client prospect is generally wavering between three options:

1) Forward the matter to an attorney and litigate;

2) Continue to negotiate; and

3) Bring in a construction mediation firm that is fully familiar with construction contracts and has the ability to mediate or arbitrate my lien case successfully without legal intervention.

The claimant tried to negotiate a settlement for six months but was unsuccessful. In this case a mechanic's lien filed against the project, a multiplex theater on 42^{nd} Street in New York City, was not the motivating factor in reaching a resolution to this dispute. In fact, the multiplex theater was a multi-billion dollar concern represented by one of the top law firms in New York City.

The mediator's strategy from the inception involved getting substantial documentation from the claimant that gave a full accounting and all supporting documentation, purchase orders, invoices, copies of contracts and proposals and change orders. The mediator realized that the key to resolving the lien dispute was proving the validity of the balance of the claimant's contract and change orders, and not whether their client or end user had the ability to pay this lien claim. The mediator's task was to overwhelm the attorney for the cinema chain with a substantial package of documentation (in the range of 300-400 pages) supporting the claim. A rapport was established with a key partner at the law firm, and the mediator diplomatically requested that they take a hard look at the claim, sent a courier to deliver the package. Also, by sending the same package to the Vice President of Construction at the cinema group, the mediator simultaneously caused both partners to peruse the back-up documentation at the same time so that they could discuss among themselves how this dispute could get resolved. Thus, if a claimant's lien documentation is sufficient, a mediator can generally force the attorneys and the claimee's principals to make a careful review of the claim, and make recommendations regarding payout. Thus, it is always better to be armed with an over-abundance of substantiating documentation that tells a full story of what happened during a construction project.

A series of follow-up telephone calls prompted a mediation meeting between the mediator and the attorney for the cinema chain. The mediator agreed to meet with one of the senior partners in the firm. A mediator can never be intimidated in a meeting of this type, but should rather show respect and be thoroughly familiar with the construction project, the documentation, the key project managers and all correspondence.

The mediator sat down with two attorneys. To survive such questioning a mediator should thoroughly know the scope of the work, the total contract and claim order balance, the number of change orders, how accessible a copy of the purchase orders from the last payment requisition is, and how to easily refer to the disputed clauses within the contract. A mediator in such a situation should remain calm, as his function is to backup the claimant's documentation. If the documentation is overwhelming a strong legal position can be set up in the event the claim has to be litigated.

In many ways it comes down to positioning for the right deal and trying to get the most money for a client. The claimee's attorneys will either put up an immediate strong defense or will listen to reason and not jeopardize their client being sued with a likely eventuality of spending time and money and losing the case. These two fears can only be exploited if the claim proof and documentation is irrefutable, and the mediator deals from a position of strategic strength. Thus, the attitude the mediator projected to the attorneys was that the mediator can either prove the case now, or later in the legal process. Because the claimant was owed $500,000 and had engaged the mediator to resolve their case at a lower fee of 8% of the recovery, there was some latitude to settle their lien claim. Everything about the case indicated that there was money available: a major Fortune 500 ultimate client, a $2 Million dollar contract just for the drywall, many other subcontractors, and the total of all contracts on the job was $50,000,000. Including all subcontractors, the mediation client was paid everything but the last $500,000. Thus, the mediator knew that this was a quantifiable lien claim.

The focus of mediation was to show the Vice President of Construction and the attorney for the cinema that although the lien claim is valid, settlement of the lien claim is possible if a fair offer is presented. In exemplary embodiments of the present invention, it is important to always let a mediation client have a conference call with the relevant parties—here the cinema's attorney and the Vice President of Construction. In this case the mediator arranged two conference calls. The mediation client can explain the construction project better than anyone and when the opposing side tries to question the mediator with a lack of the full course of events, having the client argue the rebuttal, explain and negotiate adds more credibility. There are times, of course, when a private meeting with all the relevant parties is needed prior to the involvement of a claimant's principal; however in the vast majority of mechanic's lien and construction claim disputes, the client is a mediator's key ally, engaging in conference calls and face-to-face meetings, either at the construction site or at the general contractor's Owner's Representative's or the end user's (here the cinema chain) office. The particular strategy to use in a given context depends upon various factors. If a General Contractor is questioning the quality of the claimant's work, then they should defend themselves verbally with supporting documentation. Everything comes back to the initial contract and terms and conditions of the business engagement. Also, often the project manager, the vice president of construction, the job supervisor, the facilities director, the construction managers, the project accountants or the attorneys also have inherent knowledge, perspective and opinions about the construction project, so insight into the mediation strategy can be gained by speaking to these and other key individuals.

The mediator was able to convince the cinema's attorney that they should be negotiating directly with the theatre's Vice President of Construction who was already evaluating the lien claim. In the final analysis, a back charge credit of $100,000 was agreed to by the mediation client and the Vice President of Construction of the cinema group, and a settlement check for $400,000 was approved and exchanged for all relevant close-out documents. This mediation process took 60 days to settle.

Case Study No. 3—Painting Subcontractor—General Contractor had Obstinate In-House Attorney but Needed Major Supermarket Chain's Goodwill

A Painting Subcontractor was owed $183,000 by a New Jersey based General Contractor. The General Contractor had not paid the Subcontractor for over eight months. The mechanic's lien that was filed against the project was eight months old, and thus nearing a one year deadline for taking legal action.

This case study illustrates psychological leveraging of the relationship between a General Contractor and their corporate client. A client knows his options and the cost relative to those options—mediate, settle or litigate. Their mediation efforts without third parties will generally fall short of the additional leverage that is required to push negotiations over the top and result in a final payment. A client will always prefer to settle in most cases without their construction mediation firm, collection agency or collection attorney, as they get less of the payout by using such assistance. Thus, they are trying to execute all options so they can settle in-house and not pay either a commission or a retainer. The final option, litigation, is for the most part, the most exhausting option. It is costly, intense, time consuming and sometimes long and protracted. In most cases, it is also the most financially draining option. Knowing this the mediator quoted a fee of 12%, i.e., one half of what a contingency attorney would charge in the event legal action was necessary.

In this case, the threat of legal action with the alternative of mediation as a first option was thought to be the best approach to take. However, when the mediator started working the lien case, the mediator discovered that the General Contractor was a family-owned business and the in-house attorney was the daughter of the principal partner. Legal action in itself would not be the best approach here, and the inference that such action would commence would not be the proper motivating factor to obtain resolution. Through a review of the lien file and asking the appropriate questions, it was determined that the General Contractor had as one of its primary clients a major national supermarket chain. The General Contractor worked locally, regionally and nationally for this supermarket chain. The mediator spoke with the General Contractor's in-house attorney, and explained that he was from a specialized construction mediation firm, and if he was not successful, there were attorneys ready to foreclose the lien and file a breach of contract action. The mediator called repeatedly, sent faxes and tried to set up a mediation meeting with the relevant parties.

The in-house attorney for the General Contractor was not at all phased by the mediator's initial strategic approach. The mediator realized that these strategic steps were not working, so therefore the strategy had to be changed. The mediator's due diligence investigation had revealed the General Contractors' primary client relationship, as the mediator learned this fact from another subcontractor. As a result, the mediator implemented an immediate strategy in its arsenal of psychological leveraging tools. The mediator contacted the Director of Construction and the Vice President of Finance for the General Contractor's client (i.e., the supermarket chain) by telephone and fax. The mediator also spoke with a key executive at the supermarket chain who was aware of the work of the General Contractor. After these strategic steps, a telephone call came from a high-level executive of the supermarket chain to both the mediator and the General Contractor's attorney. This softened up the attorney who realized that tens of millions of dollars in construction projects throughout the US were in jeopardy from a $183,000 dispute with the claimant painting subcontractor Here, the mediator properly used leverage There are times when a number of telephone calls and faxes over a period of several weeks to multiple decision makers at the claimee's ultimate client (here the supermarket chain) will precipitate a sit down meeting that will be a turning point in the resolution of a lien or claim.

The General Contractor and the claimant were thus able to enter into final negotiations with regard to the satisfaction of mechanics' liens, final waiver of lien and general release documents. The mediator took a step back to allow facilitation of this final payment process. There were some minor punch list issues and an authorized back charge for $20,000 against the subcontractor was made. A final settlement of $163,000 was reached in a total time frame of 60 days. The original satisfaction of lien and the final waiver documents were exchanged for the General Contractor's check for $163,000.

In this case there was no onsite mediation meeting regarding the lien claim dispute. It was all resolved via telephone and facsimile. The case illustrates how a mediator must adapt, strategize, conceptualize and leverage all key players, and continue with such efforts until final payment of the lien or claim is achieved.

Case Study No. 4—Sheet Metal Subcontractor

A Sheet Metal Subcontractor was owed $70,000 by a subcontractor that specialized in modular prefabrication work. The Prefabrication Subcontractor was hired by a General Contractor. Thus, the Sheet Metal Subcontractor was a subcontractor of a subcontractor, or third tier down. The General Contractor's client was a school construction authority of a city agency. The General Contractor was to provide prefabricated modular classrooms for the school construction authority. The lien claimant's claim was referred to as a public improvement lien against a city school project. The General Contractor was required to have a payment and performance bond through a reputable mutual surety casualty company. The claimant was close to approaching their one-year prerequisite deadline for filing against the payment bond. Many claimants file the payment bond prior and then don't have the perseverance and know-how to negotiate with the bond claim analyst or attorneys for the bonding companies to reach an agreement to settle the claim.

First, the mediator had to refile a proper proof of claim and submit it with all the relevant backup to the surety company. It is important for a mediator to preserve or perfect all of his client's lien rights to maintain leverage. Thus, a mediator should be thoroughly familiar with the various lien laws in each jurisdiction in which he operates. Telephone calls and faxes went out to the General Contractor and their Modular Mechanical Subcontractor notifying them that a proof of claim was refiled with the bonding company. While the proof of claim was taking its course through the bonding company, the mediator set up a meeting with the key executives and project managers of this project with the principals of both the Sheet Metal Subcontractor and the General Contractor.

The claimant had strong backup documentation that prompted the bonding company to ask for the position of their principal. The bonding company is supposed to conduct an independent impartial investigation of the bond claim. The mediator's actions involved reaching the nucleus of key individuals by telephone and fax, leading up to an onsite mediation meeting and walk-throughs at the construction site. After the key and crucial meetings with all the relevant parties at the city agency, the mediator felt an agreement could be reached.

The mediator repeatedly requested that the surety company's attorneys contact the project managers at the city agency and collaborate the results of their mediation meeting. The city agency informed the bonding company that the claim had merit and recommended payment by their principal. The General Contractor was aware that legal action was imminent, and also seeing that the lien could extend for a potential one-year, made the General Contractor accept the fact that in addition to losing the $70,000 dispute, it could also lose its relationship with the bonding company as well as its relationship with the specialty subcontractor (i.e., the one who hired the Sheet Metal Subcontractor claimant), who would be a third party in any potential legal action. Moreoever, this specialty subcontractor had a design patent for prefabricating modular classrooms. All this leverage against the General Contractor weighted heavily in its decision to settle this public improvement lien claim for $50,000.

Again, the multiple relationship scenario involved bringing all the parties together in one sit down meeting, having the key executives at the city agency seek out the General Contractor's bonding company contacts and having the attorneys for the bonding company make recommendation for payment to the General Contractor to finalize and pay this lien claim. The entire mediation process took 2.5 months.

Case Study No. 5—Foundations Subcontractor and Fee-Conscious Consulting Firm

A specialty subcontractor had a contract for superstructure concrete with a large construction manager working for a multi-billion dollar health institution—a hospital and cancer center. There were four integral parts of their total contract and four phases to the overall project. The claimant had been owed $1,406,395 for more than seven months. Thus, even with this substantial sum of money owed, the claimant was trying to resolve this matter in-house without an attorney. The total contract amount for the claimant was greater than $6 million dollars. They were thus owed almost ¼ of the total contract. The mediator sat down with the claimant for over two hours discussing their lien case and extracted a substantial file full of backup documentation.

The claimant had two sit-down mediation meetings prior to the mediator's involvement. It was important to convince the client that prior to a third sit down mediation meeting, the mediator would implement a series of actions to ensure that the third and final mediation meeting was conclusive. If the key individuals that are the facilitators of the construction project are unknown, then they should be determined. Upon identifying these project-related, and non-project related, key executives, a uniform message by telephone and fax can be executed as first steps in positioning for a mediation meeting with the five to seven key project decision-makers. In this case, these individuals were:
1. The owner's representative and key executives;
2. The project executives for the construction manager;
3. The in-house attorney for the construction manager;
4. The Director of Construction for the Cancer Center; and
5. The Chief Financial Officer of the Cancer Center.

Also, the mediator knew that the subcontractors' principals should also be present at a mediation meeting. The documents were sent via courier to the individuals identified above and telephone calls were made to confirm their receipt of the hard copy documents and to extract their promises to call back and speak to the next in command. As a result, a meeting was set up with the mediation client.

However, the meeting was only set up after a barrage of sending documents over a three week period. It is often necessary to reinforce that a claimant has a valid lien claim and has completed their work. In the meeting, the owner's representatives emphasized discrepancies in the payroll records, but it was agreed upon that if the claimant could recreate specific records they could be paid their contract and change order balance. The mediator knew that if the owner's representatives and the independent construction consulting firm involved could delay the subcontractor in the payment process, they would. The consultant firm was fee-oriented, billing hourly, and the mediator had to push their buttons by exacerbating their relationship with their client. The mediator was warned not to call their client. The mediator not only called their client, but put together the argument in its letters questioning why the owner's representative has not recommended payment of the undisputed portion of this $1,406,395 claim.

In fact, common sense would cause one to wonder how could the entire $1,406,395 be disputed in its entirety. After digging deeply into the underlying reasons why the claimant was not getting paid, it turned out that the obstacle was an attorney working with the consulting firm; ultimately a settlement was reached for $988,000 to be paid in two installments. This allowed the claimant to provide the additional documentation that was necessary to get paid on the balance of its contract.

The relationship between the owner's representative and the hospital cancer center was exploited by one individual. This illustrates how a mediator should develop a sense as to who is holding up settlement discussions and what the impediments are. This matter was resolved without legal action. The mediation fee charged the claimant was a 6% contingency fee; while the lien case was highly collectible, identifying the obstacles and impediments was developed by proactive involvement in the entire process from start to finish.

Case Study No. 6—Fireproofing Subcontractor

A Fireproofing Subcontractor was working for a General Contractor who went out of business. This project was a school construction authority project. There was a payment and performance bond in place. The bond company hired a new General Contractor to complete the project. There were many Subcontractors who were not paid their contract and change order balances. The Fireproofing Subcontractor was owed approximately $100,000.

The key steps that facilitated a successful mediation were as follows. The mediator contacted the bonding company attorney, forwarding the relevant claim documentation. At the same time, the mediator contacted the General Contractor's project executives and forwarded all relevant claim documentation. The mediator also contacted the project executives at the school construction authority, and submitted a written claim to all three parties and a demand for payment. This spurred a dialogue between all parties and a meeting was set up between the Fireproofing Subcontractor, the General Contractor's principal partner and the Project Executives. This meeting lasted 1½ hours and resulted in settlement and eventual processing of a change order progress payment of $40,000 for the Fireproofing Subcontractor, all partial waivers and assignment documents being signed off at the mediation meeting. These documents were necessary because the surety company took over the project once the original General Contractor went of business.

The obvious step in this situation would have been to demand payment from the new General Contractor (that took over of the project from the surety company), make a demand for payment and then recommend legal action. Thus, the mediator executed non-obvious, creative and unique steps necessary to set up the meeting. This resulted in an agreed settlement among the parties and subsequent processing of the initial change order payment, with a written commitment as to when the balance would be paid and the approximate date when the retainage would be released.

Case Study No. 7—Electrical Contractor

A mediator was hired by an Electrical Contractor that was a Subcontractor to a General Contractor who was engaged by a museum foundation. The General Contractor was required to have a payment and performance bond for the project. The amount of the lien claim was $40,111.

Initial contact was made on three fronts: the mediator contacted the attorney for the museum foundation, the mediator spoke with and sent a facsimile to the museum, the surety company agent received a call and a fax, and an immediate proof of claim was filed with the bonding company. Also, the General Contractor received a telephone call and a facsimile demand for payment and the director for the museum foundation received a telephone call and facsimile. All these steps were performed simultaneously, resulting in the General Contractor calling his Subcontractor, and offering $10,000 per month to pay off the debt. The mediator told his client not to accept this payment, due to the fact that the General Contractor had already obtained payment from the museum foundation. With the payment bond in place and everyone put on notice, subsequent faxes to the surety company and additional follow up conversations resulted in a letter from the surety company indicating that they would pay the claim if the claimant could produce a copy of liability insurance, updated payroll reports and a satisfaction of the filed mechanic's lien.

The obvious approach would have been a demand to the General Contractor, followed by legal action. The less obvious and creative approach according to the methods of the present invention involved sending several faxes to the museum, their foundation's attorney, the surety company's representative, the General Contractor and its principal, all with follow-up telephone calls. These actions resulted in a resolution of this lien claim within four weeks.

Case Study No. 8—HVAC Subcontractor

This claim involved a city housing authority that owed a claimant $225,000 for approximately one year. The claimant serviced seventy buildings for the housing authority, doing sewer and HVAC work (including the installation of air conditioning units), and they had maintenance and service contracts with the city housing authority. The housing authority had changed computer systems, resulting in vendors not getting paid due to information being lost in the system. The mediator's initial approach was to acquire all the documentation (which involved over 500 documents) that substantiated the claim. The mediator contacted the Deputy Director of Physical Compliance for the housing authority by telephone and fax, and forwarded documentation by overnight delivery. The mediator also contacted by facsimile and telephone the Deputy Director of Disbursements, and the Director of Community Operations. Subsequently, simultaneous follow-ups to all the related parties resulted in a check being processed for $710,000. The mediator was told that it would take three weeks to process a check and they insisted on mailing the check. The mediator then had the claimant write a letter to the Director of Disbursements, the Accounting Manager of Community Operations called and it was arranged for the check to be provided. The check processing took three days and the total time to mediate this claim was two weeks. The obvious steps would be to sue this city agency, the non-obvious, unique approach was to fax and speak to this small group of individuals and ask them to assist you in the process of getting your client paid. This case illustrates how when dealing with a regulated agency the diplomatic approach often works best.

Case Study No. 9—Drywall Subcontractor and Diversion of Funds Leverage

The claimant was a Drywall Subcontractor hired by a General Contractor, and the end user was a public health laboratory in a city hospital system. There was a Construction Manager that was overseeing this project. The claim amount was $156,125.90. The claimant's attorney filed a proof of claim with the bonding company. This initial step was ineffective and the claimant opted not to be the obvious step of legal action because that would be lengthy and cost prohibitive. The mediator developed a strategy that would produce the money without legal action. A preliminary investigation revealed that the General Contractor had in fact been paid by their client several months ago.

The mediator determined that this was not just a normal filing of a proof of claim. This case involved a diversion of funds issue. The first of a series of creative steps started with a facsimile to the attorney handling this claim that this was a diversion of funds issue that and the bonding company must pay this claim promptly.

After several calls and faxes to the attorney handling the claim at the bonding company, the mediator received no response, however the attorney for the bonding company notified the client's attorney that filed the claim. The mediator was thus circumvented and requested the claimant to have their attorney send a representation letter to the attorney for the bonding company that they must contact the mediator with respect to the referenced claim.

Now having full control of this claim, the mediator sent a second facsimile to the Claims Manager outlining the claim with relevant backup. The Mediator sent a third fax to the Vice President of Operations and spoke with this person outlining the diversion of funds issue. The mediator set a fourth fax to the President/CEO of the surety company; the mediator lodged a presidential complaint and called his Executive Assistant. The mediator simultaneously sent a fifth facsimile to the CFO for the General Contractor, informing him to remit payment or the mediator would be forced to obtain payment from their bonding company. After this simultaneous barrage of pages and telephone calls, the mediator knew the bonding company had to pressure the principal or the General Contractor to pay the claim.

The mediator received a telephone call from the Claims Manager for the bonding company that a check would be sent from the bonding company to the claimant's attorney. This promise of a check became tied up in a partial lien waiver document, due to legal language that favored the General Contractor. The mediator had to thus implement one final non-obvious step. In a diversion of funds matter the surety has to be impartial, and after their investigation, pay the claim. The mediator contacted by telephone and facsimile the Vice President of Internal Investigations for the surety company and their final step motivated the bonding company to give an ultimatum to their principal to release the check to the Attorney for the Subcontractor.

Case Study No. 10—Masonry Subcontractor

A Masonry Subcontractor was owed $109,600 by a General Contractor who worked for a school district in Long Island, N.Y. An engineering firm and a Construction Manager controlled the project. The conventional and obvious step to resolve this claim was to make a demand for payment with the General Contractor and recommend legal action if that did not work.

The non-obvious unique steps and strategies that were implemented involved the following actions. The mediator first contacted the school system and wrote a letter to the Assistant Superintendent of Schools and requesting that they evaluate the claim and review all of the supporting documentation that the mediator enclosed. The mediator also requested a two party check. The mediator also simultaneously contacted the engineering firm by facsimile and telephone and requested that they intervene and evaluate my client claim for payment. The mediator also simultaneously contacted the clerk at the school district that parades the information to related subcontractors on the project, the name of the payment and performance bond or surety that levies this project.

After the mediator reviewed this information, he filed a proof of claim with the bonding company of record, demanded payment and; sent a demand letter to the engineering firm and Architect for the project. Further, the mediator called and faxed the demand to all the related parties simultaneously. The mediator also contacted the Supervisor of Accounts Payable for the school district and requested payment by written demand along with supporting documentation.

The General Contractor's Controller had submitted incorrect payment requisitions to the school district. This was the primary reason that the claimant had not been paid. The mediator submitted supporting documentation in conjunction with follow up calls to:
1) The Architect;
2) The Bonding Company;
3) The School System;
4) The Construction Manager;
5) The Engineering Company; and
6) The General Contractor.

This leveraged the General Contractor into a position of settlement for $75,000. This resolution was accomplished without legal action. The mediator made the General Contractor's various business associates and relationships aware of this claim by sending key letters and faxes and telephone calls to the key decision makers of all the concerns with whom the General Contractor had an ongoing business relationship.

Appendices

As noted above, in exemplary embodiments of the present invention a construction mediation claim business can be operated by implementing the methods of the present invention. Such a business could, for example, be a stand alone business or a franchise with a franchisor providing support to it. In exemplary embodiments of the present invention such a business can, for example, utilize an expert system, as described above, to help practitioners organize each case, automatically generate the necessary documentation used in handling a case, and provide analysis and possible strategies as well as investigation data form a central database operated by the franchisor.

Submitted herewith as further illustration of the methods and systems of exemplary embodiments according to the present invention are a number of appendices from an exemplary franchise implementation of the present invention. The exemplary franchiser is listed as “COMED Construction Mediation Solutions” of New York, N.Y., and the appendices are various exemplary manuals that can be provided to prospective franchisees explaining the methods and practice of the present invention. The appendices thus elaborate upon the description of the methods of the present invention provided above, and provide sample forms and scripts for prospective users/mediators to use according to various exemplary embodiments of the present invention. The appendices are thus fully incorporated herein by this reference as if fully set forth herein. The appendices are described in a cover sheet which precedes them, and delineates what each appendix contains.

The present invention has been described in connection with exemplary embodiments and implementations, as examples only. It will be understood by those having ordinary skill in the pertinent art that modifications to any of the embodiments or preferred embodiments may be easily made without materially departing from the scope and spirit of the present invention which is defined by the appended claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed:

1. A method of mediating construction claim disputes, comprising:
fully investigating the details and context of an unpaid construction claim;
determining the actual causes of the lack of payment;
determining the key parties and the available leverage that can be used to achieve resolution; and
engaging the key parties and applying the leverage to reach settlement,
wherein at least one of said investigating, determining, engaging and applying is effected via electronic telecommunications or with the assistance of a computer.

2. The method of claim 1, wherein determining the key parties includes determining at least one of the end user of the construction project or the immediate client of the claimee.

3. The method of claim 1, wherein said applying leverage includes notifying at least one of a property owner, a surety company, a financing entity, a governmental or quasi-governmental agency and a subcontractor of the claimee.

4. The method of claim 1, wherein said fully investigating includes determining all other parties who may be or are owed monies by the claimee resulting from the same construction project.

5. A system for mediating construction claims, comprising:
an interface module;
a data processing module connected to the interface module;
a case management module connected the interface module and the data processing module; and
a database module, connected to each of the interface, data processing and case management modules,
wherein the data processing and case management modules have intelligence to assist a mediator in fully investigating the details and context of an unpaid construction claim, determining the actual causes of the lack of payment, determining the key parties and the available leverage that can be used to achieve resolution; and engaging the key parties and applying the leverage to reach settlement.

6. The system of claim 5, wherein the interface module is remote from, and connected to each of the data processing and case management modules via a data network.

7. The system of claim 5, further comprising a reporting module connected to each of the interface, data processing and case management modules.

8. The system of claim 7, wherein the reporting module generates reports at user defined intervals.
